(19) United States
(12) Patent Application Publication
(10) Pub. No.: US 2007/0234006 A1
(43) Pub. Date: Oct. 4, 2007

(54) Integrated Circuit and Metod for Issuing Transactions

(75) Inventors: Andrei Radulescu, Eindhoven (NL); Kees Gerard Willem Goossens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/568,139

(22) PCT Filed: Apr. 12, 2005
(86) PCT No.: PCT/IB05/51196

§ 371 Date: Oct. 20, 2006

(30) Foreign Application Priority Data
Apr. 26, 2004 (EP) 04101732.8

(51) Int. Cl. G06F 15/76

(52) U.S. Cl. 712/28

(57) ABSTRACT

An integrated circuit is provided comprising a plurality of processing modules (M, S) and a network (N) arranged for coupling said processing modules (M, S). Said integrated circuit comprises a first processing module (M) for encoding an atomic operation into a first transaction and for issuing said first transaction to at least one second processing module (S) . In addition, a transaction decoding means (TDM) for decoding the issued first transaction into at least one second transaction is provided.

### FIELD OF THE INVENTION

The invention relates to an integrated circuit having a plurality of processing modules and a network arranged for providing connections between processing modules, a method for issuing transactions in such an integrated circuit, and a data processing system.

### BACKGROUND OF THE INVENTION

Systems on silicon show a continuous increase in complexity due to the ever increasing need for implementing new features and improvements of existing functions. This is enabled by the increasing density with which components can be integrated on an integrated circuit. At the same time the clock speed at which circuits are operated tends to increase too. The higher clock speed in combination with the increased density of components has reduced the area which can operate synchronously within the same clock domain. This has created the need for a modular approach. According to such an approach the processing system comprises a plurality of relatively independent, complex modules. In conventional processing systems the systems modules usually communicate to each other via a bus. As the number of modules increases however, this way of communication is no longer practical for the following reasons. On the one hand the large number of modules forms a too high bus load. On the other hand the bus forms a communication bottleneck as it enables only one device to send data to the bus. A communication network forms an effective way to overcome these disadvantages.

Networks on chip (NoC) have received considerable attention recently as a solution to the interconnect problem in highly-complex chips . The reason is twofold. First, NoCs help resolve the electrical problems in new deep-submicron technologies, as they structure and manage global wires. At the same time they share wires, lowering their number and increasing their utilization. NoCs can also be energy efficient and reliable and are scalable compared to buses. Second, NoCs also decouple computation from communication, which is essential in managing the design of billion-transistor chips. NoCs achieve this decoupling because they are traditionally designed using protocol stacks, which provide well- defined interfaces separating communication service usage from service implementation.

Using networks for on-chip communication when designing systems on chip (SoC), however, raises a number of new issues that must be taken into account. This is because, in contrast to existing on-chip interconnects (e.g., buses, switches, or point-to-point wires), where the communicating modules are directly connected, in a NoC the modules communicate remotely via network nodes. As a result, interconnect arbitration changes from centralized to distributed, and issues like out-of order transactions, higher latencies, and end- to-end flow control must be handled either by the intellectual property block (IP) or by the network.

Most of these topics have been already the subject of research in the field of local and wide area networks (computer networks) and as an interconnect for parallel machine interconnect networks. Both are very much related to on-chip networks, and many of the results in those fields are also applicable on chip. However, NoC's premises are different from off-chip networks, and, therefore, most of the network design choices must be reevaluated. On-chip networks have different properties (e.g., tighter link synchronization) and constraints (e.g., higher memory cost) leading to different design choices, which ultimately affect the network services.

NoCs differ from off-chip networks mainly in their constraints and synchronization. Typically, resource constraints are tighter on chip than off chip. Storage (i.e., memory) and computation resources are relatively more expensive, whereas the number of point-to-point links is larger on chip than off chip . Storage is expensive, because general- purpose on-chip memory, such as RAMs, occupy a large area. Having the memory distributed in the network components in relatively small sizes is even worse, as the overhead area in the memory then becomes dominant.

For on-chip networks computation too comes at a relatively high cost compared to off-chip networks. An off-chip network interface usually contains a dedicated processor to implement the protocol stack up to network layer or even higher, to relieve the host processor from the communication processing. Including a dedicated processor in a network interface is not feasible on chip, as the size of the network interface will become comparable to or larger than the IP to be connected to the network. Moreover, running the protocol stack on the IP itself may also be not feasible, because often these IPs have one dedicated function only, and do not have the capabilities to run a network protocol stack.

Computer network topologies have generally an irregular (possibly dynamic) structure, which can introduce buffer cycles. Deadlock can also be avoided, for example, by introducing constraints either in the topology or routing. Fat-tree topologies have already been considered for NoCs, where deadlock is avoided by bouncing back packets in the network in case of buffer overflow. Tile-based approaches to system design use mesh or torus network topologies, where deadlock can be avoided using, for example, a turn-model routing algorithm. Deadlock is mainly caused by cycles in the buffers. To avoid deadlock, routing must be cycle-free, because of its lower cost in achieving reliable communication. A second cause of deadlock are atomic chains of transactions. The reason is that while a module is locked, the queues storing transactions may get filled with transactions outside the atomic transaction chain, blocking the access of the transaction in the chain to reach the locked module. If atomic transaction chains must be implemented (to be compatible with processors allowing this, such as MIPS), the network nodes should be able to filter the transactions in the atomic chain.

Introducing networks as on-chip interconnects radically changes the communication when compared to direct interconnects, such as buses or switches. This is because of the multi-hop nature of a network, where communication modules are not directly connected, but separated by one or more network nodes. This is in contrast with the prevalent existing interconnects (i.e., buses) where modules are directly connected. The implications of this change reside in the arbitration (which must change from centralized to distributed), and in the communication properties (e.g., ordering, or flow control).

Modern on-chip communication protocols (e.g., Device Transaction Level DTL, Open Core Protocol OCP, and AXI-Protocol) operate on a split and pipelined basis, where transactions consist of a request and a response, and the bus is released for use by others after the request issued by a master is accepted by a slave. Split pipelined communication protocols are used in multi-hop interconnects (e.g., networks on chip, or buses with bridges), allowing an efficient utilization of the interconnect.

One of the difficulties with multi-hop interconnects is how to perform atomic operations (e.g., test and set, compare-swap, etc). An atomic chain of transactions is a sequence of transactions initiated by a single master that is executed on a single slave exclusively. That is, other masters are denied access to that slave, once the first transaction in the chain claimed it. The atomic operations are typically used in multi-processing systems to implement higher-level operations, such as mutual exclusion or semaphores, it is therefore widely used to implement synchronization mechanisms between master modules (e.g., semaphores).

There are two approaches currently for implementing atomic operations (for simplicity only the test-and-set operations are described here, but other atomic operations could be treated similarly), namely a) locks or b) flags. Atomic operations can be implemented by locking the interconnect for exclusive use by the master requesting the atomic chain. Using locks, i.e. the master locks a resource for until the atomic transaction is finished, transactions always succeeds, however this may take time to be started and it will affect others. In other words, the interconnect, the slave, or part of the address space is locked by a master, which means that no other master can access the locked entity while locked. The atomicity is thus easily achieved, but with performance penalties, especially in a multi-hop interconnect. The time resources are locked is shorter because once a master has been granted access to a bus, it can quickly perform all the transactions in the chain and no arbitration delay is required for the subsequent transactions in the chain. Consequently, the locked slave and the interconnect can be opened up again in a short time.

In addition atomic operations may be implemented by restricting the granting of access to a locked slave by setting flags, i.e. the master flags a resource as being in use, and if by the time the atomic transaction completes, the flag is still set, the atomic transaction succeeds, otherwise fails. In this case the atomic transaction is executed quicker, does not affect others, but there is a chance of failure. Here for the case of an exclusive access, the atomic operation is restricted to a pair of two transactions: ReadLinked and WriteConditional. After a ReadLinked, a flag (initially reset) is set to a slave or an address range (also called a slave region). Later, a WriteConditional is attempted, which succeeds when the flag is still set. The flag is reset when other write is performed on the slave or slave range marked by the flag. The interconnect is not locked, and can still be used by other modules, however, at the price of a longer locking time of the slave.

Second is what is locked/flagged. This may be the whole interconnect, the slave (or a group of them), or a memory region (within a slave, or across several slaves).

Usually, these atomic operations consist of two transactions that must be executed sequentially without any interference from other transactions. For example, in a test-and-set operation, first a read transaction is performed, the read value is compared to a zero (or other predetermined value), and upon success, another value is written back with a write transaction. To obtain an atomic operation, no write transaction should be permitted on the same location between the read and the write transaction.

In these cases, a master (e.g., CPU) must perform two or more transactions on the interconnect for such an atomic operation (i.e., Locked Read and Write, and ReadLinked and WriteConditional). For a multi-hop interconnect, where the latency of transactions is relatively high, an atomic operation introduces unnecessary long waiting times.

Other problems caused by the high latency in the multi-hop interconnects are specific to the two implementations. For locking, it is unfeasible to lock a complete multi- hop interconnect, because it has distributed arbitration, and locking will take too much time and involve too much communication between arbiters. Therefore, in AXI- and OCP-protocols, a slave or slave region rather than the interconnect is locked. However, even in this case, a locked slave or slave region will forbid the access from all masters but the locking one. Therefore, all traffic from the other masters to that slave accumulates in the interconnect, and will cause network congestion, which is undesirable, since traffic which is not destined to the locked slave or slave region is also affected.

For exclusive access, the chances of a WriteConditional to succeed are decreasing with the increase of latency (typical in a multi-hop interconnect), and with the increasing number of masters trying to access the same slave or slave region.

One solution to limit the effects on other traffic for both schemes, is to make the slave region size as small as possible. In such a case, incident traffic which is affected (for locking) or affects (for exclusive access) the atomic operation is diminished. However, the implementation cost of having a large number of locks/flags or the complexity of implementing a dynamically programmable table to implement them is too high.

It is therefore an object of the invention to provide an integrated circuit with improved capabilities of processing an atomic chain of transactions.

This problem is solved by an integrated circuit according to claim 1, a method according to claim 6, as well as a data processing system according to claim 7.

Therefore, an integrated circuit is provided comprising a plurality of processing modules and a network arranged for coupling said modules. Said integrated circuit comprises a first processing module for encoding an atomic operation into a first transaction and for issuing said first transaction to at least one second processing module. In addition, a transaction decoding means for decoding the issued first transaction into at least one second transaction is provided.

In such an integrated circuit the load on the interconnect is reduced, i.e. there are less messages on the interconnect. Accordingly, the cost for supporting atomic operation will be reduced.

According to an aspect of the invention, said processing module includes all information required by said transaction decoding means for managing the execution of said atomic operation into said first transaction. Accordingly, all information necessary is passed to the transaction decoding means which can perform the further processing steps on its own without interaction of the first processing module.

According to a further aspect of the invention, said first transaction is transferred from said first processing module over said network to said transaction decoding means. Therefore, the execution time is shorter and thus a shorter locking of the master and the connection is achieved, since the atomic transaction is executed on side of the second processing module, i.e. the slave sid, and not by side of the first processing module, i.e. the master side.

According to a preferred aspect of the invention said transaction decoding means comprises a request buffer for queuing requests for the second processing module, a response buffer for queuing responses from said second processing module, and a message processor for inspecting incoming requests and for issuing signals to said second processing module.

According to a further aspect of the invention said first transaction comprises a header having a command, and optionally command flags and address, and a payload including zero, one or more value, wherein the execution of said command is initiated by the message processor. In the case of simple P and V, there are zero values. Extended P and V operations have one value, TestAndSet has two values.

The invention also relates to a method for issuing transactions in an integrated circuit comprising a plurality of processing modules and a network arranged for connecting said modules. A first processing module encodes an atomic operation into a first transaction and issues said first transaction to at least one second processing module. The issued first transaction is decoded by a transaction decoding means into at least one second transaction.

The invention also relates to a data processing system comprising a plurality of processing modules and a network arranged for coupling said modules. Said integrated circuit comprises a first processing module for encoding an atomic operation into a first transaction and for issuing said first transaction to at least one second processing module. In addition, a transaction decoding means for decoding the issued first transaction into at least one second transaction is provided.

The invention is based on the idea to reduce the time a resource is locked or is flagged with exclusive access to a minimum by encoding an atomic operation completely in a single transaction and by moving its execution to the slave, i.e. the receiving side.

Further aspect of the invention is described in the dependent claims.

### BRIEF DESCRIPTION OF THE DRAWINGS

FIG. 1 shows a schematic representation of a System on chip according to a first embodiment;

FIGS. 2A and 2B show a scheme for implementing an atomic operation according to a first embodiment;

FIGS. 3A and 3B show a scheme for implementing an atomic operation according to a second embodiment;

FIG. 4 show a message structure according to the preferred embodiment;

FIG. 5 show a schematic representation of the receiving side of a target module and its associated network interface; and

FIG. 6 shows a schematic representation of an alternative receiving side of a target module and its associated network interface.

### DESCRIPTION OF THE PREFERRED EMBODIMENTS

The following embodiments relate to systems on chip, i.e. a plurality of modules on the same chip communicate with each other via some kind of interconnect. The interconnect is embodied as a network on chip NOC, which may extend over a single chip or over multiple chips. The network on chip may include wires, bus, time-division multiplexing, switch, and/or routers within a network. At the transport layer of said network, the communication between the modules is performed over connections. A connection is considered as a set of channels, each having a set of connection properties, between a first module and at least one second module. For a connection between a first module and a single second module, the connection comprises two channels, namely one from the first module to the second module, i.e. the request channel, and a second from the second module to the first module, i.e. the response channel. The request channel is reserved for data and messages from the first module to the second module, while the response channel is reserved for data and messages from the second to the first module. However, if the connection involves one first and N second modules, 2*N channels are provided. The connection properties may include ordering (data transport in order), flow control (a remote buffer is reserved for a connection, and a data producer will be allowed to send data only when it is guaranteed that space is available for the produced data), throughput (a lower bound on throughput is guaranteed), latency (upper bound for latency is guaranteed), the lossiness (dropping of data), transmission termination, transaction completion, data correctness, priority, or data delivery.

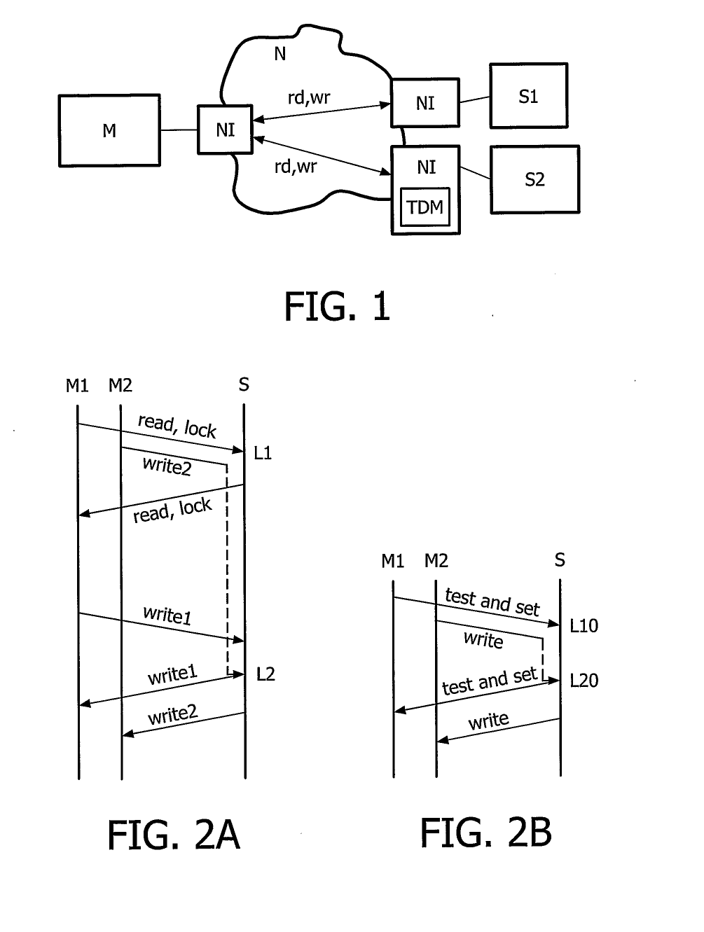

FIG. 1 shows a System on chip according to the invention. The system comprises a master module M, two slave modules S1, S2. Each module is connected to a network N via a network interface NI, respectively. The network interfaces NI are used as interfaces between the master and slave modules M, S1, S2 and the network N. The network interfaces NI are provided to manage the communication of the respective modules and the network N, so that the modules can perform their dedicated operation without having to deal with the communication with the network or other modules. The network interfaces NI can send requests such as read rd and write wr between each other over the network N.

The modules as described above can be so-called intellectual property blocks IPs (computation elements, memories or a subsystem which may internally contain interconnect modules) that interact with network at said network interfaces NI.

In particular, a transaction decoding means TDM is arranged in at least one network interface NI associated to one of the slaves S1, S2. Atomic operations are implemented as special transaction to be included in a communication protocol. The idea is to reduce the time a resource is locked or is flagged with an exclusive access to a minimum. To achieve this, an atomic operation is encoded completely in a single transaction by the master's side, and its execution is moved to the slave side.

An implementation thereof is illustrated in FIGS. 2A and 2B. A traditional atomic operation using locking is shown in FIG. 2A, and the atomic operation according to a first embodiment is shown in FIG. 2B.

Therefore, FIG. 2A shows a basic representation of a communication scheme between a first and second master M1, M2 and a slave S within a network on chip environment. The first master M1 requests a ‘read & lock’ operation, i.e. read a value in the slave S and lock the slave S, and the slave S returns a response ‘read & lock’, possibly returning a read value. The slave S is then locked (L1) to the master M1 so that a request ‘write2’ from the second master M2 is blocked, i.e. its execution is delayed. After the master M1 received the response ‘read & lock’ from the slave S, it issues a request ‘write1’ to the slave S in order to write a value into the slave S. This second request from the master M1 is received by the slave S and a response ‘write1’ is forwarded to the master M1 and the locking of the slave S is released (L2), as the operation is terminated. Accordingly, the slave S was locked from LI to L2 and the request ‘write2’ is blocked until L2, i.e. the release of the slave S. Now the slave S can proceed to the request ‘write2’ from the second master M2.

In FIG. 2B a basic representation of a communication scheme between a first and second master M1, M2 and a slave S within a network on chip environment according to a first embodiment is shown. The master M1 requests a ‘test and set’ operation. All information to handle the request at the slave side is included into the single atomic transaction by the master M1. The single atomic transaction ‘test-and-set’ is received by the transaction decoding means TDM associated to the slave. The execution of the transaction is issued by the atomic transaction decoding means TDM, the slave performs the requested operation and the slave issues a response ‘test-and-set’ when the transaction has been executed. The slave is locked to the master M1 upon receiving the first request at L10 and released when its has terminated the execution of the transaction and it has issued the response ‘test-and-set’ at L20. Accordingly, a request ‘write’ from the second master M2 is blocked until the slave is released at L20.

In other words, the slave is blocked only for the duration of the execution of the atomic operation at the slave, which is much shorter then the execution as shown in FIG. 2A. Moreover, the master is simpler since there is no need to implement the atomic operations in the master itself. There is less burden on the master (which does not need to execute part of the atomic operations). However, the complexity is moved to the interconnect, in particular the network interfaces, which can be reused.

When comparing the communication schemes as shown in FIG. 2A and FIG. 2B, it can be observed that the locking time (L1-L2) in the traditional implementation according to FIG. 2A is longer, because the master M1 participates in the execution of the atomic operation, i.e. request ‘read, lock’ and request ‘write 1’. Hence, the slave S is locked for twice the latency of the network plus the time the master M1 executes its part of the atomic operation. In all this time, traffic destined to slave S (e.g., from a master M2) is blocked.

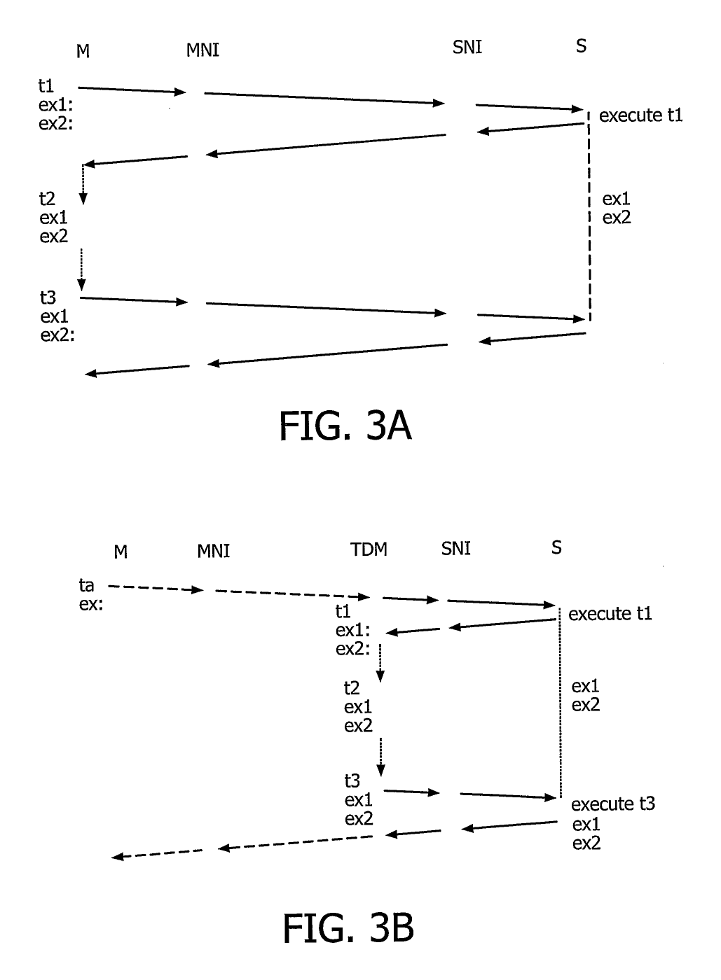

FIGS. 3A and 3B show a scheme for implementing an atomic operation according to a second embodiment, which is the preferred embodiment. A traditional atomic operation using locking is shown in FIG. 3A, and the atomic operation according to the second embodiment is shown in FIG. 3B.

In FIG. 3A in particular the communication between a master M and a slave S as shown in FIG. 1 together with the intermediate network interface MNI of the master M and the intermediate network interface SNI of the slave S. In particular, the underlying principles are described for two example execution, namely a LockedRead as first execution example ex1 and a ReadLinked as second execution example ex2.

The master M issues a first transaction t1, which may be a LockedRead as execution ex1 or a ReadLinked as execution ex2. The transaction t1 is forwarded to the network interface MNI of the master M, via the network N to the network interface SNI of the slave and finally to the slave S. The slave S executes the transaction t1 and possibly returns some data to the master via the network interface SNI and the network interface MNI associated to the master. In the meantime the slave S is blocked for an execution LockedRead or Readlinked, and is flagged for an execution Write or WriteConditional, respectively. When the master M receives the response of the slave S it executes a second transaction t2, which is in both above mentioned cases execution ex1 and ex2 a comparison. Thereafter, the master M issues a third transaction t3, which is a Write command, in case of execution ex1, and a WriteConditional command, respectively, in case of execution ex2, to the slave. The slave S receives this command and returns a corresponding response. Thereafter, the slave S is released.

In FIG. 3B a basic representation of a communication scheme between a master M and a slave S within a network on chip environment is shown according to the second embodiment. The basic structure of the underlying network on chip environment corresponds to the environment as described in FIG. 3A, however a transaction decoding means TDM is additionally included into the network on chip environment. The master M issues an atomic transaction ta like a TestAndSet which is forwarded to the transaction decoding means TDM via the network interface MNI of the master M.

As described according to FIG. 3A two different execution examples for implementations or decoding of the atomic transaction ta of a TestAndSet command are described, namely LockedRead and Write as first execution example ex1 and ReadLinked and WriteConditional as second execution example ex2.

Here, the master M issues an atomic transaction ta. The decoding of the atomic transaction ta and the processing of first, second and third transactions t1, t2, t3 as described according to FIG. 3A, which have been performed by the master M, are now performed by the transaction decoding means TDM. Therefore, the transaction decoding means TDM decodes the atomic transaction ta into transaction t1, i.e. into the first or second execution example ex1 or ex2. Accordingly, as soon as the slave S receives the first transaction t1, i.e. ex1 or ex2, from the transaction decoding means TDM via the network interface SNI associated to the slave, the first transaction t1 is executed and the slave issues a response possibly containing some data to the transaction decoding means TDM. The transaction decoding means TDM performs the comparison according to the second transaction t2, i.e. according to the first or second execution example ex1 or ex2, wherein it is a comparison for both cases. Thereafter, the transaction decoding means TDM issues a Write as ex1 or WriteConditional transaction as ex2 to the slave S, which executes the third transaction and unlocks the slave in case of a LockedRead and a Write, i.e. the first execution example ex1, and a ReadLinked and WriteConditional, i.e. the second execution example ex2, which succeeds if the flag is still set. A corresponding response is issued to the master M.

As shown in FIG. 3B there are fewer transactions, which have to be forwarded over the network. In addition, the master M has a lower processing burden as merely one atomic transaction has to be issued, while this atomic transaction is expended into a plurality of simpler transactions at the transaction decoding means TDM. The master M according to the second embodiment has to be aware of the atomic transactions as some processing steps are now not performed by the master M but by the transaction decoding means TDM. For example, the comparison t2 between the first and second transaction t1 and t3 is performed by the transaction decoding means TDM.

Alternatively, the slave may. also be aware of atomic transactions, but in this case the transaction decoding means TDM may be part of the slave S. This will result in an simplified network as the transaction decoding means TDM is moved from the network and arranged in the slave S. In addition fewer transactions will therefore past between the network interface SNI associated to the slave and the slave itself. In particular, this may only be the atomic transaction.

Examples of an atomic transactions could be test and set, and compare and swap. In both cases, two data values must be carried by the request of the transaction: the value to be compared (CMPVAL) and the value to be written (WRVAL). In both examples, CMPVAL is compared with the value at the transaction's address. If they are the same, WRVAL is written. The response from the slave is the new value at that location for test and set, and the old value for compare and swap. Note that any boolean function is possible instead of the simple comparison (e.g., less than or equal, as used in the semaphore extension described below).

More advanced, and simpler from a transaction point of view, are semaphore transactions, which will call P and V without any parameter. P waits until it has access to the address specified in the transaction, than attempts to decrement the value at the location specified by the transaction's address. If the value is positive, than it decrements it and success is returned. If the value is zero or negative, it is not changed and failure is returned. V succeeds always and increments the location at the address specified.

Extensions of P and V transactions are possible, in which the value (VAL) to be incremented/decremented is specified as a data parameter of the P/V transactions. If the value at the transaction's address is larger than or equal to VAL, P decrements by VAL the location at the transaction's address, and returns success. Otherwise it leaves the location unchanged and returns failure. V succeeds always in increments the addressed location by VAL.

The invention is related to the encoding of the operation as transactions, which are implemented and executed in the interconnect at the slave side.

A test-and-set transaction is especially relevant in IC designs with high-latency interconnects (e.g., buses with bridges, networks on chip), which will become inherent with the increase in the chip complexity.

The advantages of an above mentioned test-and-set transaction include that there is no need to lock the interconnect. There is less load (i.e., fewer messages) on the interconnect. The execution time of a test-and-set operation at a master is shorter. A CPU/master merely needs to perform a single instruction instead of three for a test-and-set operation (read, comparison, write). Moreover, the cost for supporting atomic operation is reduced. However, a disadvantage is that current CPUs do not provide such an instruction yet.

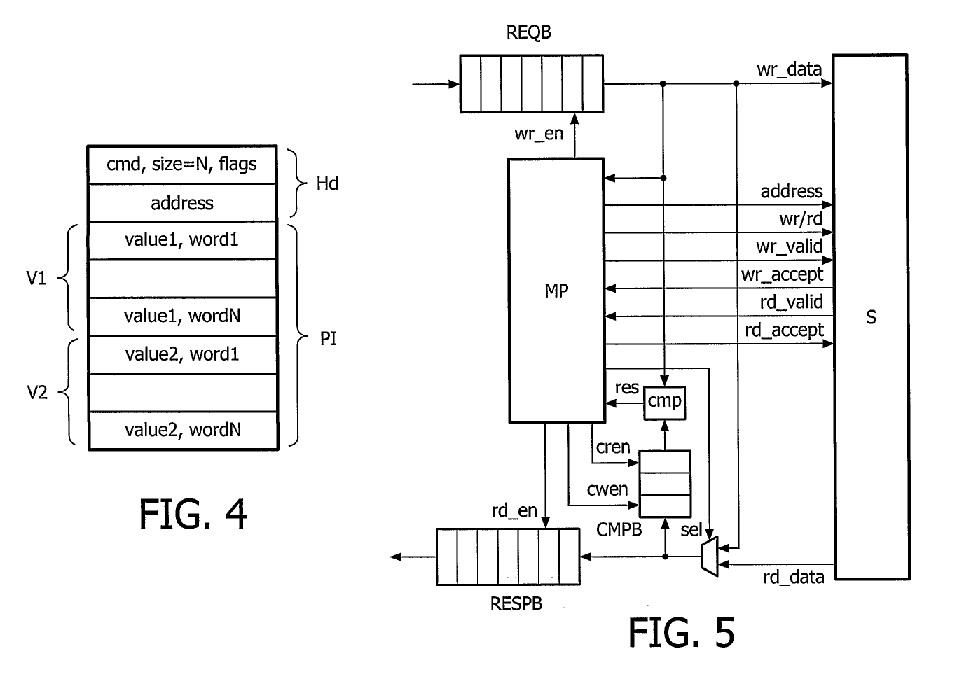

FIG. 4 shows a message structure according to the first embodiment. Here, a request message consists of a header hd and a payload pl. The header hd consists of a command cmd (e.g., read, write, test and set), flags (e.g., payload size, bit masks, buffered), and an address. The payload p1 may be empty (e.g., for a read command), may contain one value v1(e.g., write command), or two values V1, V2 (e.g., test-and-set command).

FIG. 5 shows the receiving side, i.e. the slave S and its associated network interface NI. The slave's network interface and in particular a transaction decoding means TDM implements a test and set operation. Only those parts of the network interface relevant to the test-and-set operation implementation, i.e. the transaction decoding means TDM are shown.

The transaction decoding means TDM in the slave network interface contains two message queues, namely a request buffer REQB and a response buffer RESB, a message processor MP, a comparator CMP, a comparator buffer CMPB and a selector SEL. The transaction decoding means TDM comprises a request input connected to the request buffer REQB, a response output connected to the output of the response buffer RESB, an output for data wr_data to be written into the slave, an input for data rd_data output from the slave, control outputs for an address ‘address’ in the slave S, a selection output to select reading/writing wr/rd, and output for valid writing wr_valid, an output for reading acceptance rd_accept, an input for writing acceptance wr_accept, and for valid reading rd_valid. The message processor MP comprises the following inputs: the output of the request buffer REQB, the write accept input wr_accept, the read valid input rd_valid and the result output res of the comparator CMP. The message processor comprises the following outputs: the address output, the write/read selection output wr/rd, the write validation output wr_valid, the read acceptance output rd_accept, the selection signal SEL for the selector, the write enable signal wr_en, the read enable signal rd_en, the read-enable signal for the comparator cren, and the write-enable signal for the comparator cwen.

The request buffer or queue REQB accommodates the requests (e.g., read, write, test and set commands with their flags, addresses and possibly data) received from a master via the network and which are to be delivered at the slave. The response buffer or queue RESB accommodates messages produced by the slave S for the master M as a response to the commands (e.g., read data, acknowledgments).

Furthermore, the message processor MP inspects each message header hd being input to the request buffer REQB. Depending on the command cmd and the flags in the header hd, it drives the signals towards the slave. In case of a write command, it sets the wr/rd signal to write, and provides data on the wr_data output by setting wr_valid. For a read command, it sets the wr/rd to read, and sets the selector SEL to pass read data rd-data through. When read data is present on the input rd-data (i.e., rd_valid is high), rd_en is set (i.e., ready to accept), and when the response queue accepts the data (signal not shown for simplicity), rd_accept is generated. The selector SEL forwards the output of the request buffer REQB or the rd_data output to the response buffer RESB or the comparator buffer CMPB in response of the selector signal SEL of the message processor MP.

For a test-and-set command, the message processor MP first issues a read command to the slave, and stores the received data in the comparator buffer or queue CMPB. Then, the message processor MP activates both the request buffer REQB and comparator buffer CMPB to produce data through the comparator CMP for size=N words. If every pair of words has identical words, then the comparison test succeeded, and the next value in the request buffer or queue REQB (also of size=N words) is written to the slave S. In this case, the written value is also returned directly via the response queue REQB to the master M. If the test failed, the second value in the request queue is discarded (i.e., no write to slave), and a second read is issued to the same address to be returned to the master via the response queue REQB.

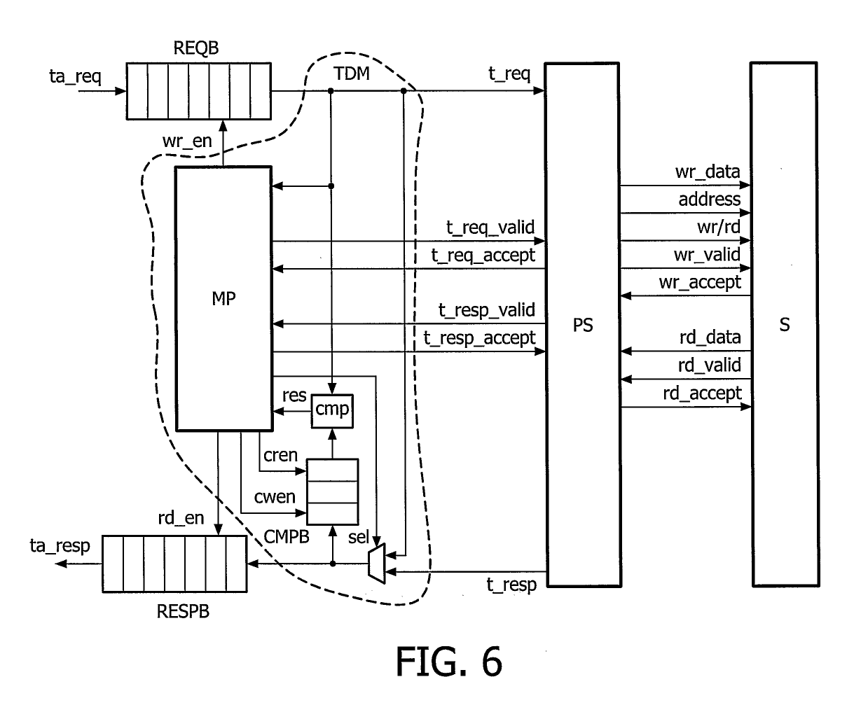

FIG. 6 shows a schematic representation of an alternative arrangement of the receiving side as shown in FIG. 5. The operation of the arrangement of FIG. 6 substantially corresponds to the operation of the arrangement of FIG. 5. The arrangement of FIG. 6 corresponds to the arrangement of FIG. 5 but the message processor MP of FIG. 5 is split into two parts, namely into a message processor MP and a protocol shell PS in between the message processor MP and the slave S. Here, those parts which correspond to the transaction decoding means TDM, namely the message processor MP, the comparator CMP, the comparator queue CMPB and the selector sel, are encircled by the dashed line. The request queue REQB and the response queue RESPQ may be part of the network N.

The protocol shell PS serves to translate the messages of the message processor MP into a protocol with which the slave S can communicate, e.g. a bus protocol. In particular, the messages or signals transaction request t_req, transaction request valid t_req_valid and transaction request accept t_req accept as well as the signals transaction response t_resp, transaction response valid t_resp_valid and transaction response accept t_resp_accept are translated into the respective output and input signals of the slave S as described according to FIG. 5

Alternatively, the transaction decoding means TDM and the protocol shell PS may be implemented in a network interface NI associated to the slave S or as part of the network N.

The above described network on chip may be implemented on a single chip or in a multi-chip environment.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

Furthermore, any reference signs in the claims shall not be construed as limiting the scope of the claims.

1. Integrated circuit comprising a plurality of processing modules (M, S) and a network (N) arranged for coupling said modules (M, S; IP), comprising
a first processing module (M) for encoding an atomic operation into a first transaction and for issuing said first transaction to at least one second processing module (S), and
a transaction decoding means (TDM) for decoding the issued first transaction into at least one second transaction.

2. Integrated circuit according to claim 1, wherein
said first processing module (M) is adapted to include all information required by said transaction decoding means (TDM) for managing the execution of said atomic operation into said first transaction.

3. Integrated circuit according to claim 2, wherein
said first transaction being transferred from said first processing module (M) over said network (N) to said transaction decoding means (TDM).

4. Integrated circuit according to claim 1, wherein
said transaction decoding means (TDM) comprises a request buffer (REQB) for queuing requests for the second processing module (S), a response buffer (RESPB) for queuing responses from said second processing module (S), and a message processor (MP) for inspecting incoming requests and for issuing signals to said second processing module (S)

5. Integrated circuit according to claim 4, wherein
said first transaction comprises a header having a command, and optionally command flags and an address, and a payload with zero, one or more values,
wherein the execution of said command is initiated by the message processor (MP).

6. Method for issuing transaction in an integrated circuit comprising a plurality of processing modules (M; S) and a network (N) arranged for connecting said modules (M; S), further comprising the steps of:
encoding an atomic operation into a first transaction and issuing said first transaction to at least one second processing module by a first processing module (M),
decoding the issued first transaction into at least one second transaction by a transaction decoding means (TDM).

7. Data processing system, comprising:
a plurality of processing modules (M, S) and a network (N) arranged for coupling said modules (M, S), comprising
a first processing module (M) for encoding an atomic operation into a first transaction and for issuing said first transaction to at least one second processing module (S), and
a transaction decoding means (TDM) for decoding the issued first transaction into at least one second transaction.
